(19) United States
(12) Patent Application Publication
(10) Pub. No.: US 2012/0100822 A1
(43) Pub. Date: Apr. 26, 2012

(54) WIRELESS NETWORK RECEIVER FOR SELECTIVELY RECEIVING OR EXPOSING AN ELECTRICAL CONNECTOR

(75) Inventor: Chun-Yu Hsu, Taipei County (TW)

(73) Assignee: BANDRICH, INC., Xindian City (TW)

(21) Appl. No.: 12/911,713

(22) Filed: Oct. 25, 2010

(51) Int. Cl. H04B 1/08

(52) U.S. Cl. 455/348

(57) ABSTRACT

A wireless network receiver for selectively receiving or exposing an electrical connector includes a wireless network receiving unit, a two-stage switch unit and a slidable cover unit. The wireless network receiving unit includes a wireless network receiving module, and the electrical connector is electrically connected to and disposed on one end of the wireless network receiving module. The two-stage switch unit includes a movable module disposed in the wireless network receiving module, and the movable module is selectively positioned in a first position or a second position. The slidable cover unit covers slidably one part of the wireless network receiving module and connects the two-stage switch unit, and the electrical connector is selectively received by or exposed from the slidable cover unit according to the position of the movable module in the first position or the second position.

### BACKGROUND OF THE INVENTION

1. Field of the Invention

The instant disclosure relates to a wireless network receiver, and more particularly, to a wireless network receiver for selectively receiving or exposing an electrical connector.

2. Description of Related Art

The development of the Internet and the popularization of personal computers enable data from different places to be communicated. However, most of the current Internet infrastructure is connected with wires made of different materials, such as optical fibers. Thus, using wireless network card eliminates the aforementioned problems, and creates a convenient communications environment.

Typically, portable information technology (IT) products, such as laptops require wireless cards to enable wireless communications. Wireless cards have various designs and features based on the specifications of different wireless communication protocols. Developments and growth of the next generation mobile communications technologies increase communication quality and data transmission speed. Recently, major mobile communication technologies focus on accelerating data transmission speed and improving data transmission quality. Several major mobile communication protocols, such as globe system for mobile communications (GSM) of second generation (2G) standards, general packet radio service (GPRS) of 2.5G standards, wideband code division multiple access (WCDMA) of 3G standards and even recent high speed downlink packet access (HSDPA) of 3.5G standards have been developed and continuously improved to substantially accelerate the transmission speed.

Generally, the wireless cards use antennas to receive and transmit wireless signals. Antenna dimension, size and location are major design challenges that influence the performance of signal reception and transmission. Further, different countries adopt different mobile communication technologies and different band frequencies. User environment of the portable electronic device is varied following the mobility of the user. Thus, using a single antenna does not satisfy the requirements of good signal reception and transmission.

The wireless network card can be replaced by wireless network receiver that has an interface to connect to the computer. The interface may be a universal serial bus (USB) interface. The USB interface is usually capped with a detachable cap to protect the USB interface. However, the detachable cap may easily be lost, disappear or become loosened with the USB interface after a period of time. Thus, the USB interface is lack of protection. The collision between the USB and the surrounding environment would reduce the life of the USB interface. For the foregoing reasons, there is a need for protecting the USB interface efficiently.

### SUMMARY OF THE INVENTION

One particular aspect of the instant disclosure is to provide a wireless network receiver for selectively receiving or exposing an electrical connector by knock action or pressing action.

To achieve the above-mentioned advantages, the instant disclosure provides a wireless network receiver for selectively receiving or exposing an electrical connector, including: a wireless network receiving unit, a two-stage switch unit and a slidable cover unit. The wireless network receiving unit includes a wireless network receiving module, and the electrical connector is electrically connected to and disposed on one end of the wireless network receiving module. The two-stage switch unit includes a movable module disposed in the wireless network receiving module, and the movable module is selectively positioned in a first position or a second position. The slidable cover unit covers slidably one part of the wireless network receiving module and connects the two-stage switch unit, and the electrical connector is selectively received by or exposed from the slidable cover unit according to the position of the movable module in the first position or the second position.

Therefore, the electrical connector can be selectively hidden in the slidable cover unit or exposed from the slidable cover unit by repeatedly pressing the end of the wireless network receiving unit.

To further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention that they be used for limiting the instant disclosure.

### BRIEF DESCRIPTION OF THE DRAWINGS

FIG. 1A shows a perspective, exploded, schematic view of the wireless network receiver according to the first embodiment of the instant disclosure;

FIG. 1B shows a perspective, assembled, schematic view of the wireless network receiver according to the first embodiment of the instant disclosure (when hiding the electrical connector);

FIG. 1C shows a perspective, exploded, schematic view of the two-stage switch unit of the wireless network receiver according to the first embodiment of the instant disclosure;

FIG. 1D shows a lateral, assembled, schematic view of the two-stage switch unit operating in one state according to the first embodiment of the instant disclosure;

FIG. 1E shows a lateral, assembled, schematic view of the two-stage switch unit operating in another state according to the first embodiment of the instant disclosure;

FIG. 1F shows a top, schematic view of the multiple-stage switch of the two-stage switch unit according to the first embodiment of the instant disclosure;

FIG. 1G shows a perspective, assembled, schematic view of the wireless network receiver according to the first embodiment of the instant disclosure (when exposing the electrical connector);

FIG. 2A shows a perspective, exploded, schematic view of the wireless network receiver according to the second embodiment of the instant disclosure;

FIG. 2B shows a perspective, schematic view of the movable module of the wireless network receiver according to the second embodiment of the instant disclosure;

FIG. 3 shows a perspective, exploded, schematic view of the wireless network receiver according to the third embodiment of the instant disclosure;

FIG. 4A shows a perspective, exploded, schematic view of the wireless network receiver according to the fourth embodiment of the instant disclosure;

FIG. 4B shows a partial, perspective, assembled, schematic view of the wireless network receiver according to the fourth embodiment of the instant disclosure (when hiding the electrical connector);

FIG. 4C shows a partial, perspective, assembled, schematic view of the wireless network receiver according to the fourth embodiment of the instant disclosure (when exposing the electrical connector);

FIG. 5A shows a perspective, exploded, schematic view of the wireless network receiver according to the fifth embodiment of the instant disclosure;

FIG. 5B shows a partial, perspective, assembled, schematic view of the wireless network receiver according to the fifth embodiment of the instant disclosure (when hiding the electrical connector);

FIG. 5C shows a partial, perspective, assembled, schematic view of the wireless network receiver according to the fifth embodiment of the instant disclosure (when exposing the electrical connector);

FIG. 6A shows a perspective, exploded, schematic view of the wireless network receiver according to the sixth embodiment of the instant disclosure;

FIG. 6B shows a partial, perspective, assembled, schematic view of the wireless network receiver according to the sixth embodiment of the instant disclosure (when hiding the electrical connector);

FIG. 6C shows a partial, perspective, assembled, schematic view of the wireless network receiver according to the sixth embodiment of the instant disclosure (when exposing the electrical connector);

FIG. 7A shows a perspective, exploded, schematic view of the wireless network receiver according to the seventh embodiment of the instant disclosure;

FIG. 7B shows a partial, perspective, assembled, schematic view of the wireless network receiver according to the seventh embodiment of the instant disclosure (when hiding the electrical connector);

FIG. 7C shows a partial, perspective, assembled, schematic view of the wireless network receiver according to the seventh embodiment of the instant disclosure (when exposing the electrical connector); and

FIG. 8 shows a top schematic view of two ends of the guiding pin respectively slid in the single-stage groove and the guiding groove according to the sixth and the seventh embodiments of the instant disclosure.

### DETAILED DESCRIPTION OF THE PREFERRED EMBODIMENTS

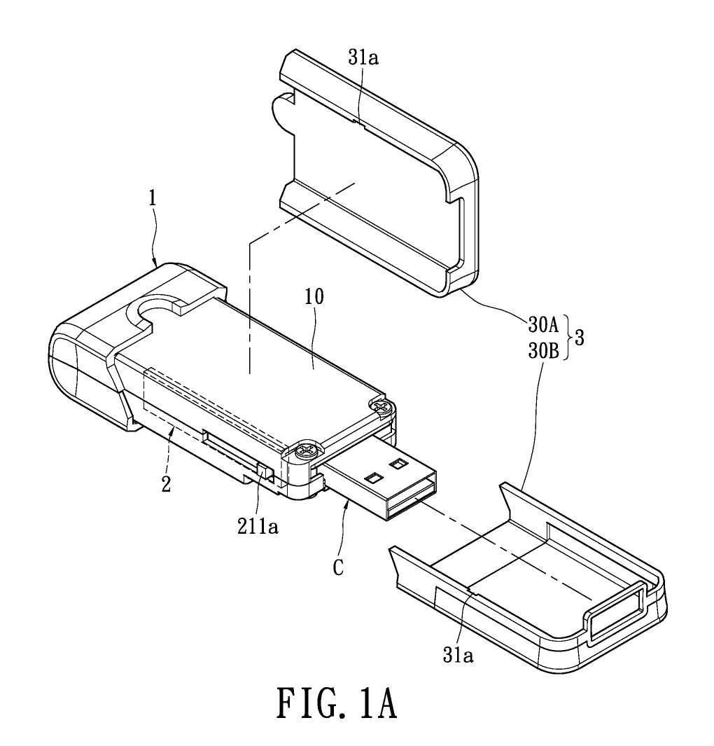

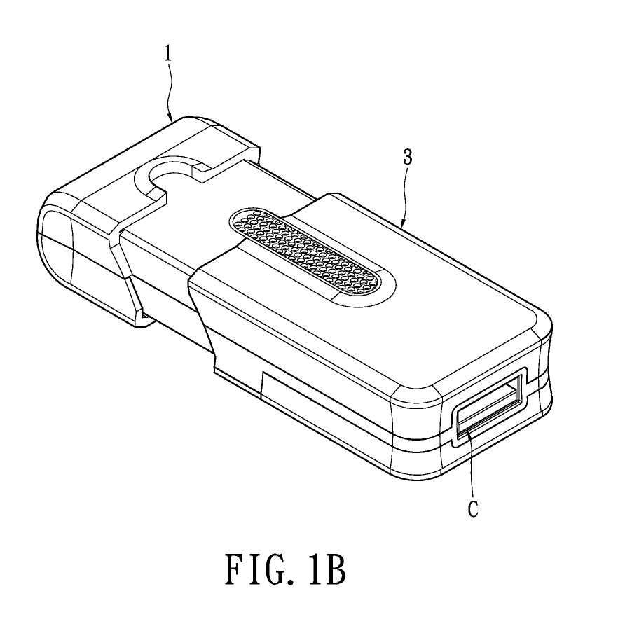

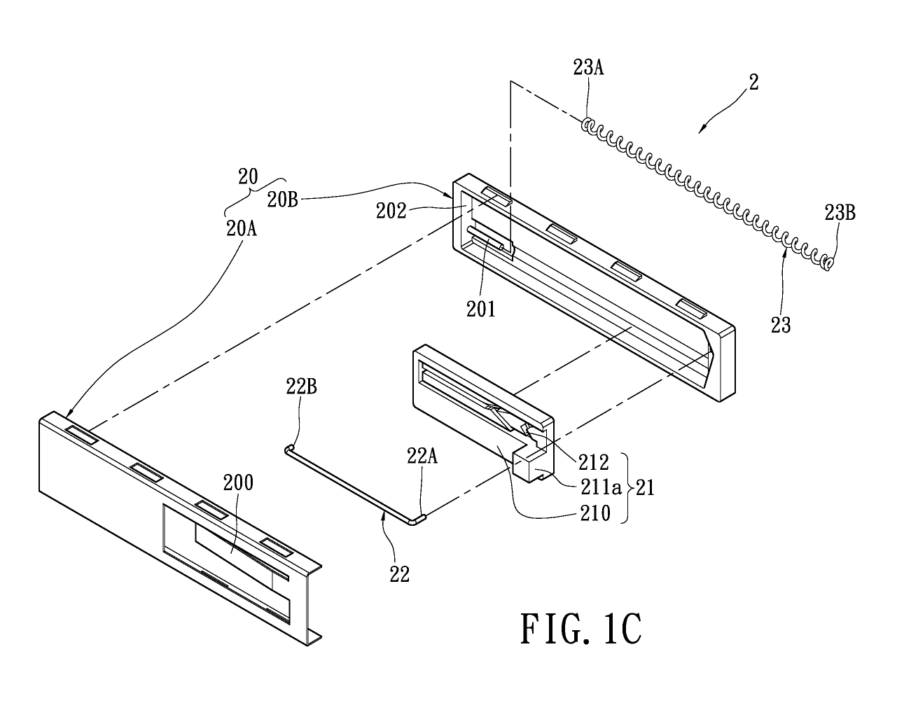

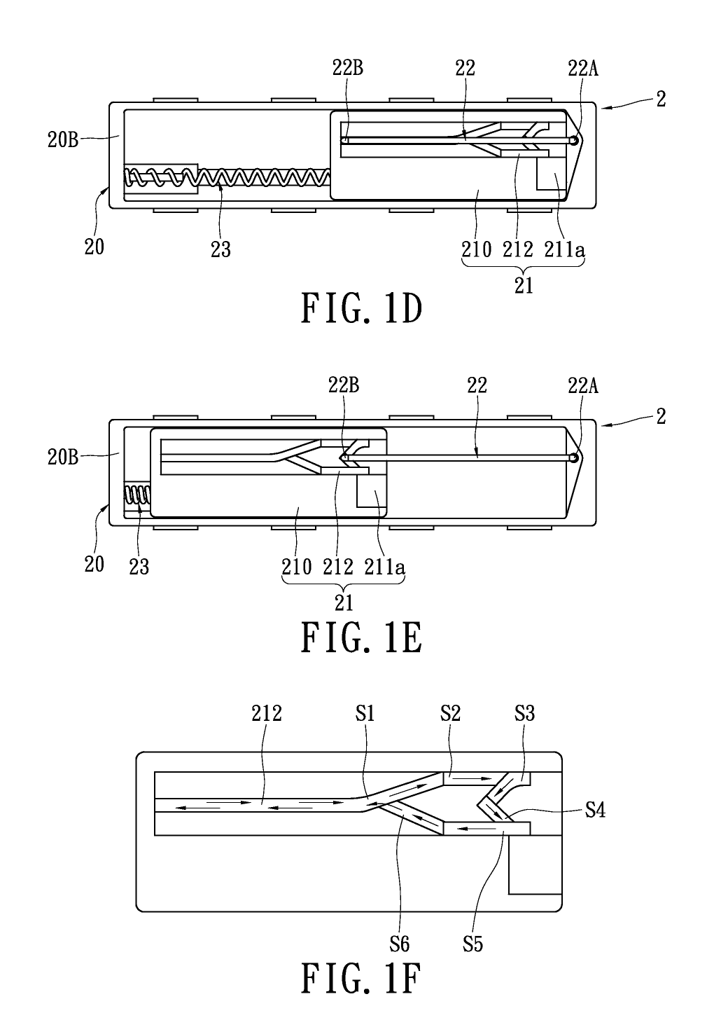

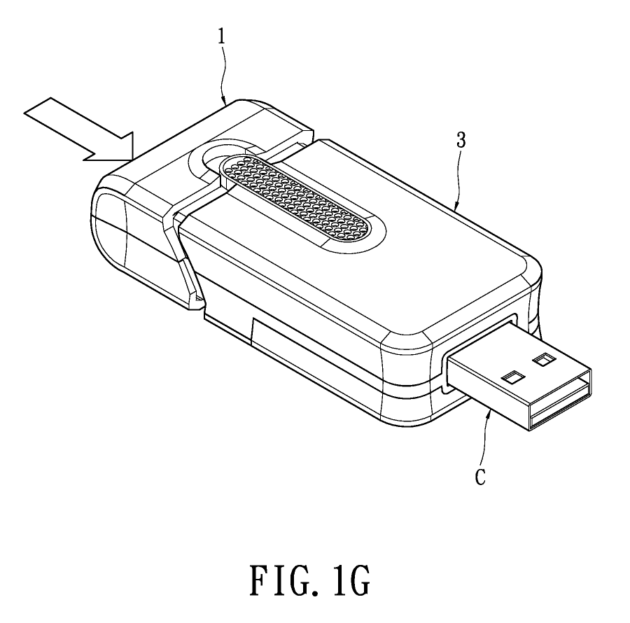

Referring to FIGS. 1A to 1G, the first embodiment of the instant disclosure provides a wireless network receiver for selectively receiving or exposing an electrical connector C by knock action or pressing action, including: a wireless network receiving unit 1, a two-stage switch unit 2 and a slidable cover unit 3.

Referring to FIGS. 1A and 1B, the wireless network receiving unit 1 includes a wireless network receiving module 10, and the electrical connector C can be electrically connected to and disposed on one end of the wireless network receiving module 10. For example, the electrical connector C may be a USB connector.

The two-stage switch unit 2 is disposed or positioned in the wireless network receiving module 10, and the two-stage switch unit 2 includes at least one protruding movable block 211a exposed from the wireless network receiving module 10.

The slidable cover unit 3 slidably covers one part of the wireless network receiving module 10 and connects the two-stage switch unit 2. For example, the slidable cover unit 3 includes a top cover 30A and a bottom cover 30B mated together or integrated with each other to form a one-piece element, and the slidable cover unit 3 has at least one fixing groove 31a formed on the inner surface thereof to receive and fix the protruding movable block 211a (for example, one part of the fixing groove 31a is formed on the inner surface of the top cover 30A and other part of the fixing groove 31a is formed on the inner surface of the bottom cover 30B). Hence, the protruding movable block 211a can be moved according to the movement of the slidable cover unit 3.

Referring to FIGS. 1C to 1F, for example, the two-stage switch unit 2 includes a hollow casing 20 positioned in the wireless network receiving module 10, a movable module 21 slidably disposed in the hollow casing 20 (the movable module 21 is also slidably disposed in the wireless network receiving module 10) and selectively positioned in a first position (as shown in FIG. 1D) or a second position (as shown in FIG. 1E) of the hollow casing 20, a guiding pin 22 disposed in the hollow casing 20 and an elastic element 23 disposed between the inner surface 202 of the hollow casing 20 and the movable module 21, and the elastic element 23 may be a compression spring.

The hollow casing 20 includes a top casing 20A and a bottom casing 20B mated together or integrated with each other to form a one-piece element, and the top casing 20A has a pressing portion 200 for continuously pressing the guiding pin 22. In addition, the movable module 21 includes a movable body 210, at least one protruding movable block 211a disposed on the movable body 210 and exposed from the hollow casing 20, and a multiple-stage groove 212 formed on the movable body 210.

One end 22A of the guiding pin 22 is positioned in the hollow casing 20, and the other end 22B of the guiding pin 22 is slidably disposed in the multiple-stage groove 212 and selectively positioned in a first position (as shown in FIG. 1D, wherein the top casing 20A is removed temporarily) or a second position (as shown in FIG. 1E, wherein the top casing 20A is removed temporarily) in the multiple-stage groove 212. In other words, the other end 22B of the guiding pin 22 can be selectively positioned in the first position (as shown in FIG. 1D) or a second position (as shown in FIG. 1E) due to the design of different high and low planes in the multiple-stage groove 212.

For example, referring to FIG. 1F, the multiple-stage groove 212 has a first surface S1, a second surface S2, a third surface S3, a fourth surface S4, a fifth surface S5 and a sixth surface S6. The first surface S1 is a plane, the second surface S2 is a incline slowly upward extended from the first surface S1, the third surface S3 is a plane lower than the second surface S2, the fourth surface S4 is a plane lower than the third surface S3, the fifth surface S5 is a plane lower than the fourth surface S4, and the sixth surface S6 is a incline slowly upward extended from the fifth surface S5, thus end of the sixth surface S6 is higher than the first surface S1. In other words, when the protruding movable block 211a of the movable module 21 is pushed by a predetermined distance, the other end 22B of the guiding pin 22 can be selectively moved from the end of the first surface S1 to the third surface S3 and positioned on fourth surface S4 (as shown from FIG. 1D to FIG. 1E) or be moved from the third surface S3 to the first surface S1 and positioned on the end first surface S1 (as shown from FIG. 1E to FIG. 1D).

One end 23A of the elastic element 23 is disposed around a fixing rod 201 of the hollow casing 20 and is abutted against the inner surface 202 of the hollow casing 20, and the other end 23B of the elastic element 23 is positioned under the movable module 21 or embedded into the movable module 21, thus the two end (23A and 23B) of the elastic element 23 are respectively positioned between the inner surface 202 of the hollow casing 20 and the movable module 21.

Hence, the electrical connector C can be selectively received by or exposed from the slidable cover unit 3 according to the position of the movable module 21 positioned in the first position (as shown in FIG. 1D) or the second position (as shown in FIG. 1E).

In other words, when a user holds the slidable cover unit 3 and presses the end of the wireless network receiving unit 1 by his/her thumb (shown as the direction of the arrow in FIG. 1G), the movable module 21 of the two-stage switch unit 2 is pushed by the slidable cover unit 3 due to the match of the fixing groove 31a with the protruding movable block 211a (as shown in FIG. 1A). Therefore, when the movable module 21 is pushed by a predetermined distance (it means the movable module 21 is moved from the first position in FIG. 1D to the second position in FIG. 1E), the other end 22B of the guiding pin 22 can be moved from the first position in multiple-stage groove 212 (as shown in FIG. 1D) to the second position in multiple-stage groove 212 (as shown in FIG. 1E), and the elastic element 23 is compressed at the same time.

In addition, when the user holds the slidable cover unit 3 and presses the end of the wireless network receiving unit 1 again by his/her thumb, the movable module 21 of the two-stage switch unit 2 is pushed by the slidable cover unit 3 again due to the match of the fixing groove 31a with the protruding movable block 211a (as shown in FIG. 1A). Therefore, when the movable module 21 is pushed by a predetermined distance (it means the movable module 21 is moved from the second position in FIG. 1E to the first position in FIG. 1D), the other end 22B of the guiding pin 22 can be moved from the second position in multiple-stage groove 212 (as shown in FIG. 1E) to the first position in multiple-stage groove 212 (as shown in FIG. 1D). Therefore, the electrical connector C can be selectively hidden in the slidable cover unit 3 (as shown in FIG. 1B) or exposed from the slidable cover unit 3 (as shown in FIG. 1G) by pressing the end of the wireless network receiving unit 1.

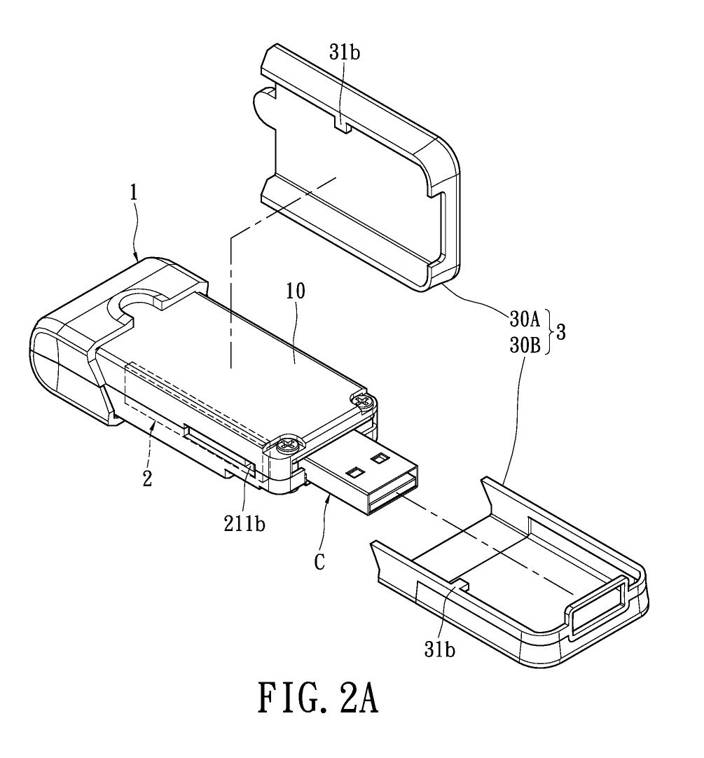

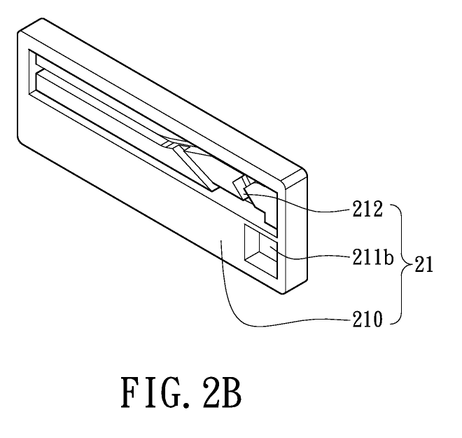

Referring to FIGS. 2A and 2B, the second embodiment of the instant disclosure provides a wireless network receiver for selectively receiving or exposing an electrical connector C by knock action or pressing action, including: a wireless network receiving unit 1, a two-stage switch unit 2 and a slidable cover unit 3. The wireless network receiving unit 1 includes a wireless network receiving module 10, and the electrical connector C can be electrically connected to and disposed on one end of the wireless network receiving module 10. The slidable cover unit 3 slidably covers one part of the wireless network receiving module 10 and connects the two-stage switch unit 2. For example, the slidable cover unit 3 includes a top cover 30A and a bottom cover 30B mated together or integrated with each other to form a one-piece element.

The difference between the second embodiment and the first embodiment is that: in the second embodiment, the movable module 21 includes a movable body 210, at least one movable groove 211b disposed on the movable body 210 and a multiple-stage groove 212 formed on the movable body 210. In addition, the slidable cover unit 3 has at least one fixing block 31b formed on the inner surface thereof and fixedly received in the movable groove 211b (for example, one part of the fixing block 31b is disposed on the inner surface of the top cover 30A and other part of the fixing block 31b is disposed on the inner surface of the bottom cover 30B). Hence, the movable groove 211b can be moved according to the movement of the slidable cover unit 3.

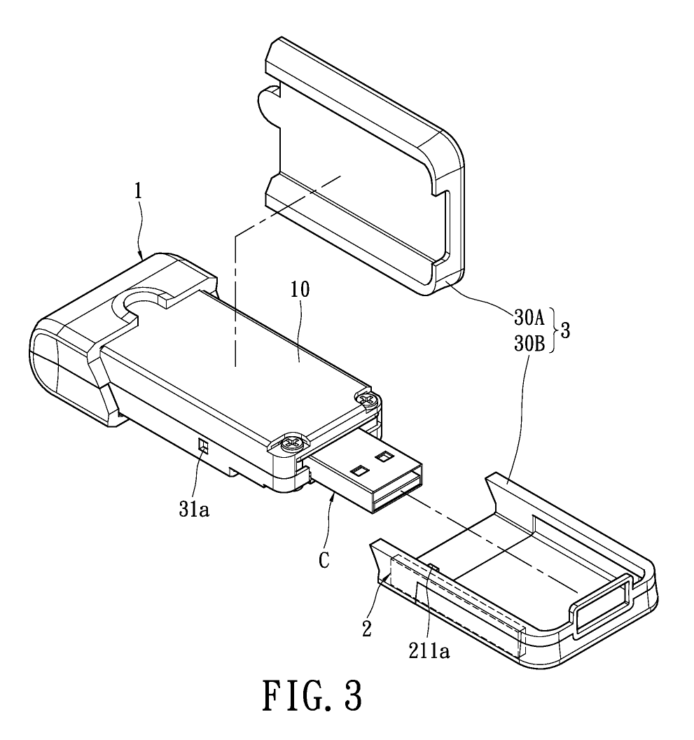

Referring to FIG. 3, the third embodiment of the instant disclosure provides a wireless network receiver for selectively receiving or exposing an electrical connector C by knock action or pressing action, including: a wireless network receiving unit 1, a two-stage switch unit 2 and a slidable cover unit 3.

The difference between the third embodiment and the first embodiment is that: in the third embodiment, the two-stage switch unit 2 is disposed in the slidable cover unit 3, and the two-stage switch unit 2 includes at least one protruding movable block 211a exposed from the slidable cover unit 3. The wireless network receiving unit 1 includes a wireless network receiving module 10, the electrical connector C can be electrically connected to and disposed on one end of the wireless network receiving module 10, and the wireless network receiving module 10 is coupled to the two-stage switch unit 2. For example, the wireless network receiving module 10 has at least one fixing groove 31a formed on the outer surface thereof to receive and fix the protruding movable block 31a, thus the protruding movable block 211a can be moved according to the movement of the wireless network receiving module 10. In other words, the two-stage switch unit includes a movable module 21 (the same as the movable module 21 in FIG. 1C) that can be selectively positioned in a first position or a second position in the slidable cover unit 3 by pressing the end of the wireless network receiving unit 1, thus the electrical connector C can be selectively received by or exposed from the slidable cover unit 3 according to the position of the movable module 21 positioned in the first position or the second position.

In addition, the protruding movable block 211a can be replaced by a movable groove and the fixing groove 31a can be replaced by a fixing block, thus the electrical connector C can be also selectively received by or exposed from the slidable cover unit 3 according to the position of the movable module 21 positioned in the first position or the second position.

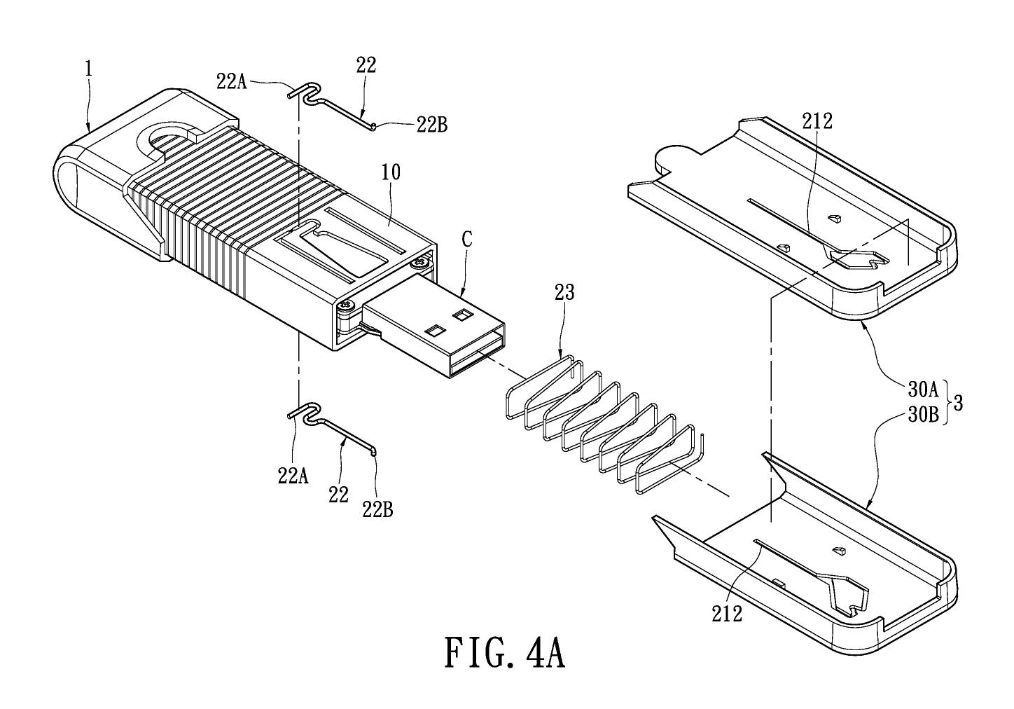

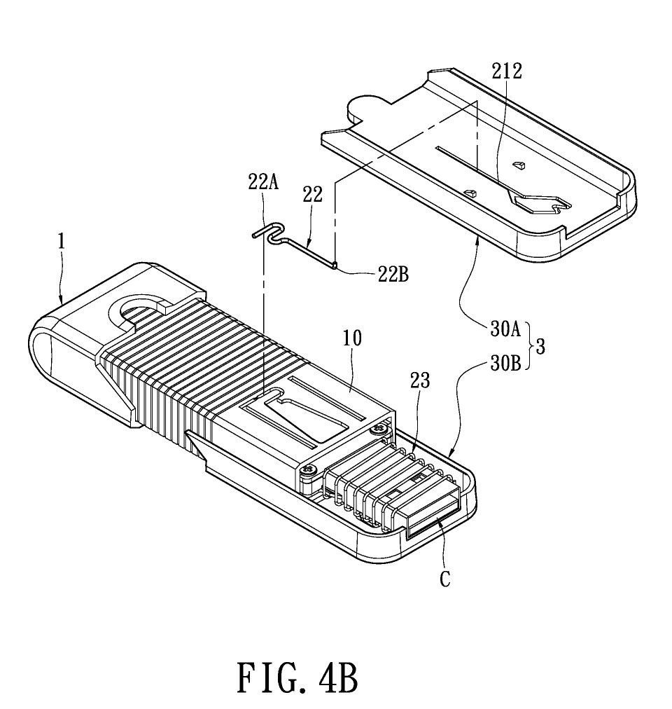

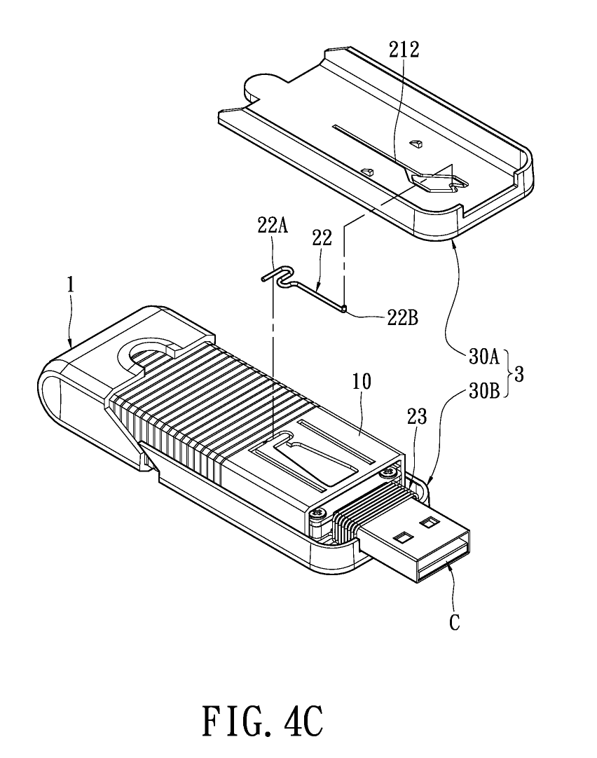

Referring to FIGS. 4A to 4C, the fourth embodiment of the instant disclosure provides a wireless network receiver for selectively receiving or exposing an electrical connector C by knock action or pressing action, including: a wireless network receiving unit 1, a slidable cover unit 3 and an elastic unit.

The wireless network receiving unit 1 includes a wireless network receiving module 10, and the electrical connector C can be electrically connected to and disposed on one end of the wireless network receiving module 10. The wireless network receiving module 10 has a first guiding pin 22 disposed on a first lateral surface thereof, and one part (one end 22A) of the first guiding pin 22 is positioned on the first lateral surface of the wireless network receiving module 10.

The slidable cover unit 3 includes a top cover 30A and a bottom cover 30B mated together or integrated with each other to form a one-piece element, and the slidable cover unit 3 can slidably covers the wireless network receiving module 10. The slidable cover unit 3 has a first multiple-stage groove 212 formed on a first inner surface thereof and corresponding to the first guiding pin 22. A first end (another other end 22B) of the first guiding pin 22 is selectively positioned in a first position (as shown in FIG. 4B) or a second position (as shown in FIG. 4C) in the first multiple-stage groove 212 by pressing the slidable cover unit 3, thus the electrical connector C can be selectively hidden in the slidable cover unit 3 (as shown in FIG. 4B) or exposed from the slidable cover unit 3 (as shown in FIG. 4C) according to the position of the first end (another other end 22B) of the first guiding pin 22 positioned in the first position or the second position in the first multiple-stage groove 212. In addition, the elastic unit has at least one elastic element 23 positioned between the wireless network receiving module 10 and the slidable cover unit 3.

Moreover, the wireless network receiving module 10 has a second guiding pin 22 disposed on a second lateral surface thereof, one part (one end 22A) of the second guiding pin 22 is positioned on the second lateral surface of the wireless network receiving module 10. The slidable cover unit 3 has a second multiple-stage groove 212 formed on a second inner surface thereof and corresponding to the second guiding pin 22 (as shown in FIG. 4A). A first end (another other end 22B) of the second guiding pin 22 is selectively positioned in a first position (as shown in FIG. 4B) or a second position (as shown in FIG. 4C) in the second multiple-stage groove 212 by pressing the slidable cover unit 3, thus the electrical connector C can be selectively hidden in the slidable cover unit 3 (as shown in FIG. 4B) or exposed from the slidable cover unit 3 (as shown in FIG. 4C) according to the position of the first end (another other end 22B) of the second guiding pin 22 in the first position or the second position in the second multiple-stage groove 212.

In other words, the electrical connector C can be selectively hidden in the slidable cover unit 3 (as shown in FIG. 4B) or exposed from the slidable cover unit 3 (as shown in FIG. 4C) according to the position of the two ends 22B of the two guiding pins 22 respectively positioned in the first position (as shown in FIG. 4B) or the second position (as shown in FIG. 4C) of the two multiple-stage grooves 212.

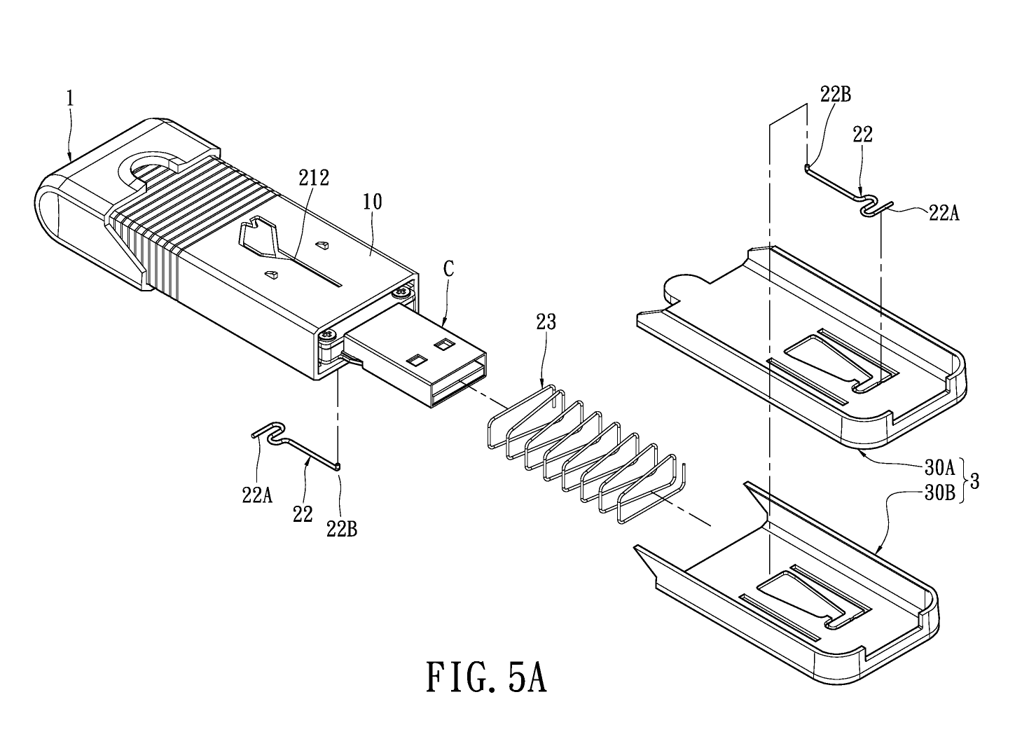

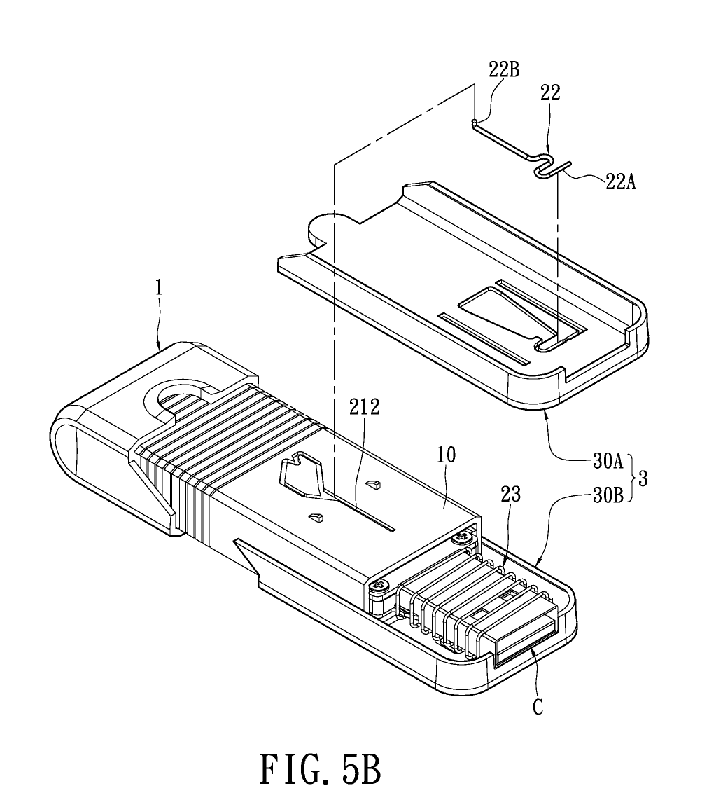

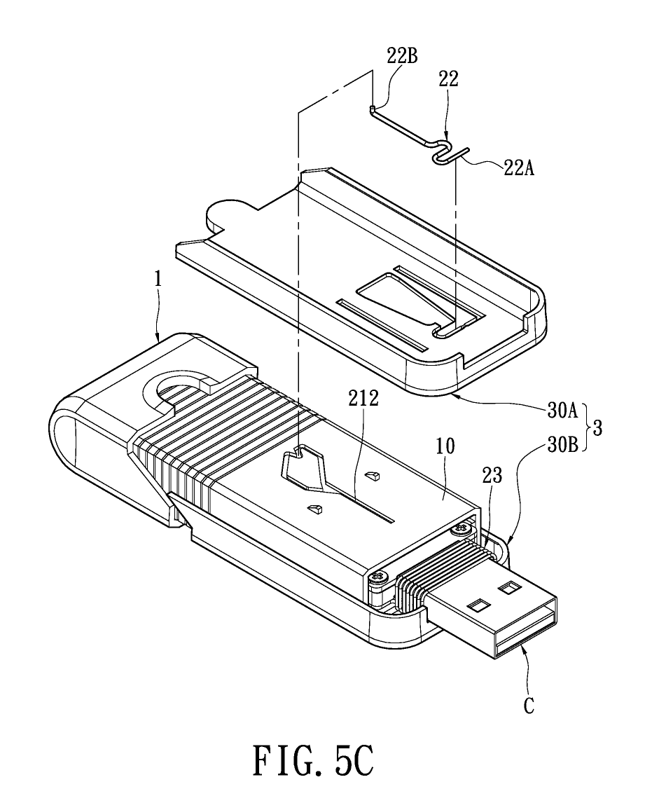

Referring to FIGS. 5A to 5C, the fifth embodiment of the instant disclosure provides a wireless network receiver for selectively receiving or exposing an electrical connector C by knock action or pressing action, including: a wireless network receiving unit 1, a slidable cover unit 3 and an elastic unit.

The wireless network receiving unit 1 includes a wireless network receiving module 10, and the electrical connector C can be electrically connected to and disposed on one end of the wireless network receiving module 10. The wireless network receiving module 10 has a first multiple-stage groove 212 disposed on a first lateral surface thereof.

The slidable cover unit 3 includes a top cover 30A and a bottom cover 30B mated together or integrated with each other to form a one-piece element, and the slidable cover unit 3 can slidably covers the wireless network receiving module 10. The slidable cover unit 3 has a first guiding pin 22 formed on a first inner surface thereof and corresponding to the first multiple-stage groove 212, and one part (one end 22A) of the first guiding pin 22 is positioned on the first inner surface of the slidable cover unit 3. A first end (another other end 22B) of the first guiding pin 22 is selectively positioned in a first position (as shown in FIG. 5B) or a second position (as shown in FIG. 5C) in the first multiple-stage groove 212 by pressing the slidable cover unit 3, and the electrical connector C can be selectively hidden in the slidable cover unit 3 (as shown in FIG. 5B) or exposed from the slidable cover unit 3 (as shown in FIG. 5C) according to the position of the first end (another other end 22B) of the first guiding pin 22 in the first position (as shown in FIG. 5B) or the second position (as shown in FIG. 5C) in the first multiple-stage groove 212. In addition, the elastic unit has at least one elastic element 23 positioned between the wireless network receiving module 10 and the slidable cover unit 3.

Moreover, the wireless network receiving module 10 has a second multiple-stage groove 212 disposed on a second lateral surface thereof. The slidable cover unit 3 has a second guiding pin 22 formed on a second inner surface thereof and corresponding to the second multiple-stage groove 212, and one part (one end 22A) of the second guiding pin 22 is positioned on the second inner surface of the slidable cover unit 3. A first end (another other end 22B) of the second guiding pin 22 is selectively positioned in a first position (as shown in FIG. 5B) or a second position (as shown in FIG. 5C) in the second multiple-stage groove 212 by pressing the slidable cover unit 3, thus the electrical connector C can be selectively hidden in the slidable cover unit 3 (as shown in FIG. 5B) or exposed from the slidable cover unit 3 (as shown in FIG. 5C) according to the position of the first end (another other end 22B) of the second guiding pin 22 in the first position or the second position of the second multiple-stage groove 212.

In other words, the electrical connector C can be selectively hidden in the slidable cover unit 3 (as shown in FIG. 5B) or exposed from the slidable cover unit 3 (as shown in FIG. 5C) according to the position of the two ends 22B of the two guiding pins 22 respectively positioned in the first position (as shown in FIG. 5B) or the second position (as shown in FIG. 5C) of the two multiple-stage grooves 212.

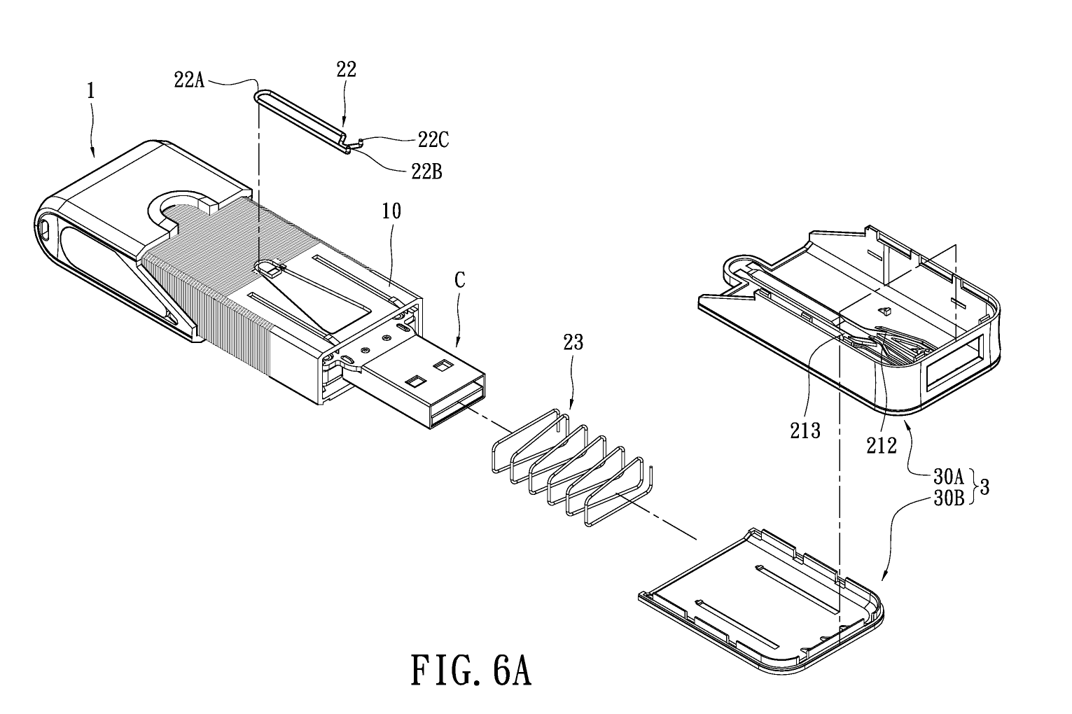

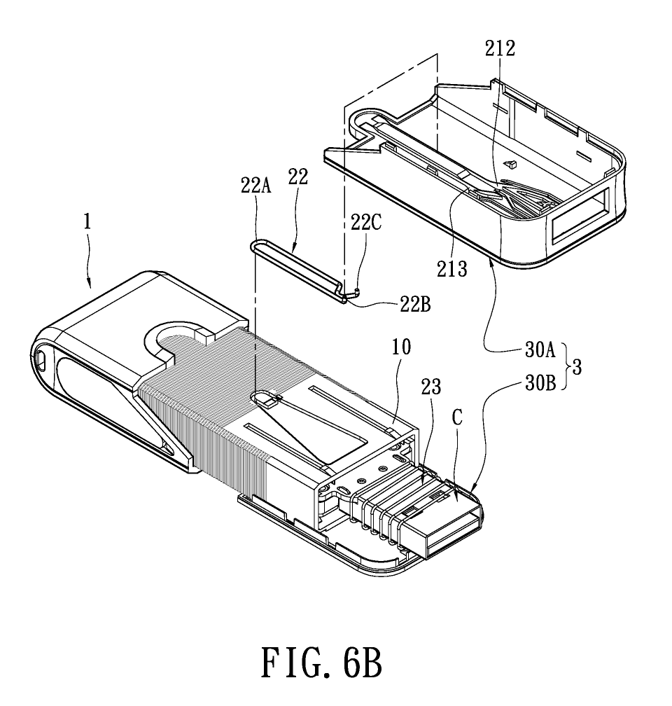

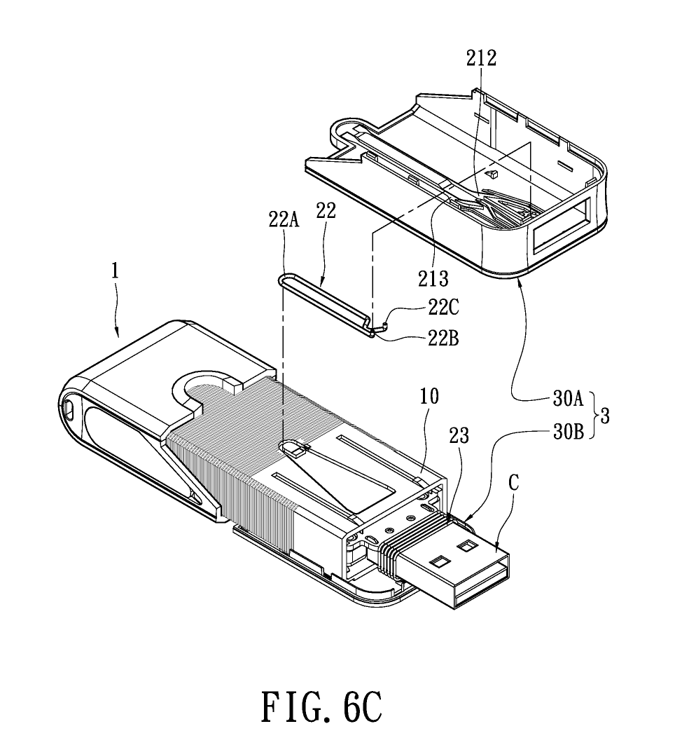

Referring to FIGS. 6A to 6C, the sixth embodiment of the instant disclosure provides a wireless network receiver for selectively receiving or exposing an electrical connector C by knock action or pressing action, including: a wireless network receiving unit 1, a slidable cover unit 3 and an elastic unit. The wireless network receiving unit 1 includes a wireless network receiving module 10, and the electrical connector C can be electrically connected to and disposed on one end of the wireless network receiving module 10. The wireless network receiving module 10 has a first guiding pin 22 with U shape disposed on a first lateral surface thereof, one part 22A of the first guiding pin 22 is positioned on the first lateral surface of the wireless network receiving module 10, and the first guiding pin 22 has a first end 22B and a second end 22C extended toward the substantially same direction.

The slidable cover unit 3 includes a top cover 30A and a bottom cover 30B mated together or integrated with each other to form a one-piece element, and the slidable cover unit 3 can slidably covers the wireless network receiving module 10. The slidable cover unit 3 has a first single-stage or multiple-stage groove 212 and a first guiding groove 213 formed on the first inner surface thereof, and the first guiding groove 213 is adjacent to the first single-stage or multiple-stage groove 212. The first single-stage or multiple-stage groove 212 corresponds to one part of the first guiding pin 22, and the first guiding groove 213 corresponds to another part of the first guiding pin 22. The first end 22B of the first guiding pin 22 is selectively positioned in a first position (as shown in FIG. 6B) or a second position (as shown in FIG. 6C) in the first single-stage or multiple-stage groove 212 by pressing the slidable cover unit 3, thus the electrical connector C can be selectively hidden in the slidable cover unit 3 (as shown in FIG. 6B) or exposed from the slidable cover unit 3 (as shown in FIG. 6C) according to the position of the first end 22B of the first guiding pin 22 positioned in the first position or the second position of the first single-stage or multiple-stage groove 212. In addition, the second end 22C of the first guiding pin 22 can be also selectively positioned in a first position (as shown in FIG. 6B) or a second position (as shown in FIG. 6C) in the first guiding groove 213 by pressing the slidable cover unit 3. Moreover, the elastic unit has at least one elastic element 23 positioned between the wireless network receiving module 10 and the slidable cover unit 3.

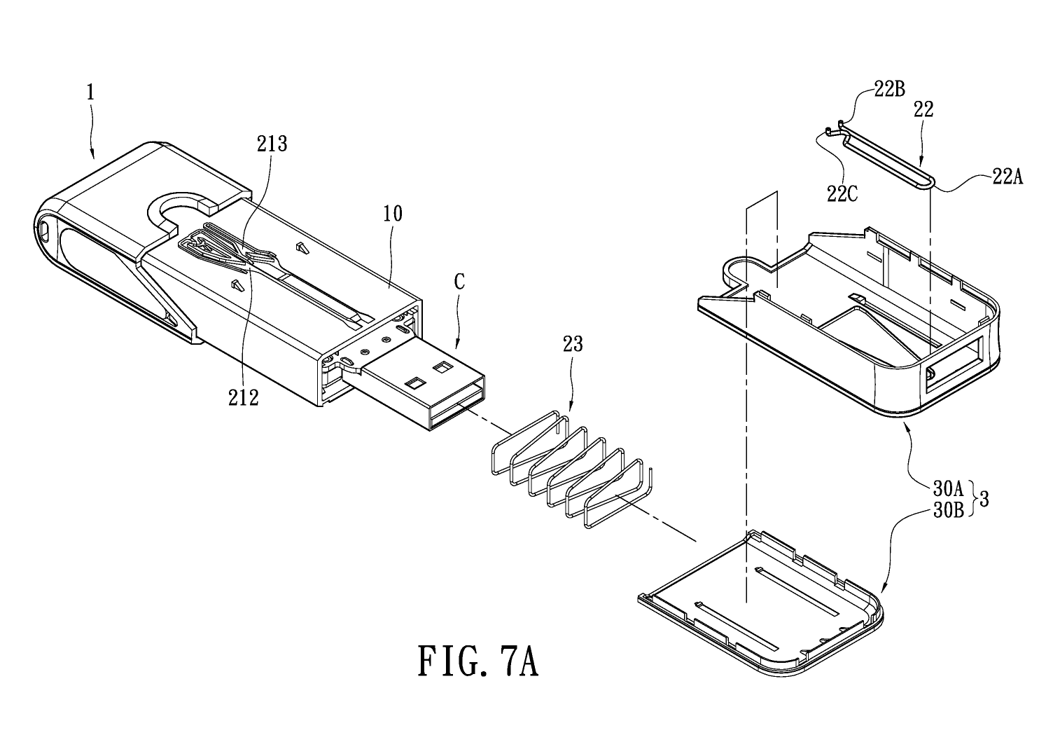

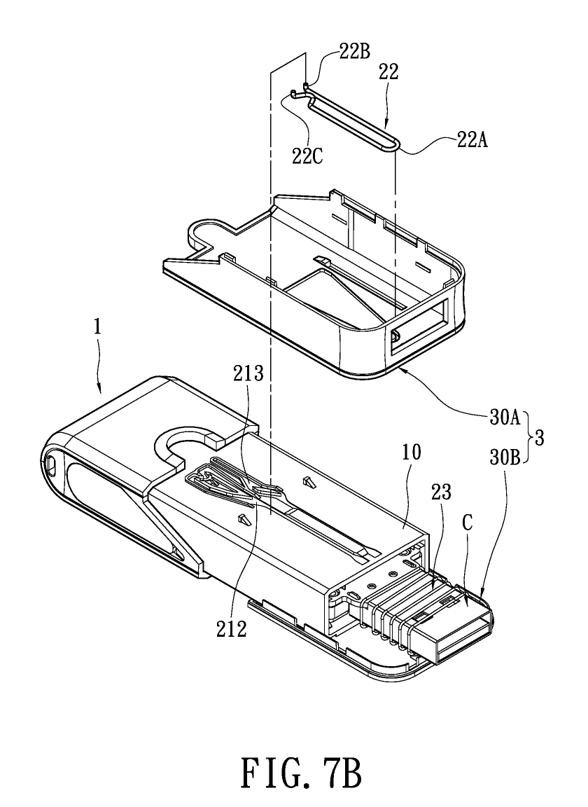

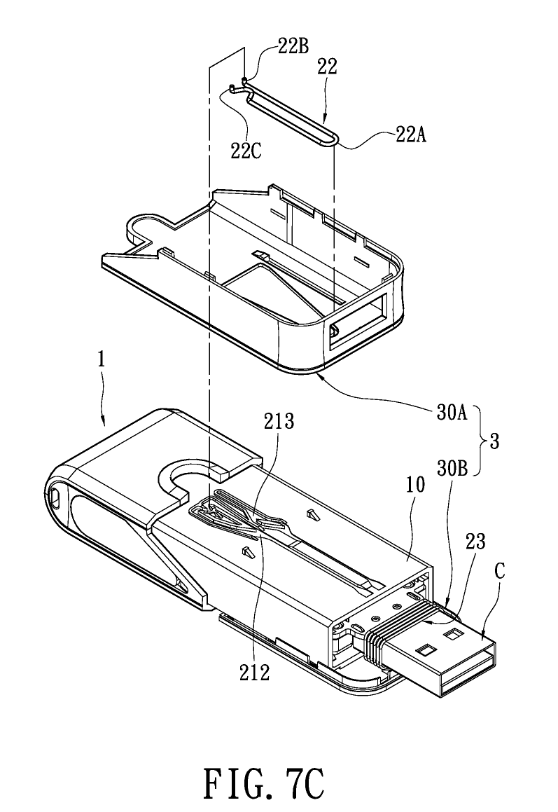

Referring to FIGS. 7A to 7C, the seventh embodiment of the instant disclosure provides a wireless network receiver for selectively receiving or exposing an electrical connector C by knock action or pressing action, including: a wireless network receiving unit 1, a slidable cover unit 3 and an elastic unit. The wireless network receiving unit 1 includes a wireless network receiving module 10, and the electrical connector C can be electrically connected to and disposed on one end of the wireless network receiving module 10. The wireless network receiving module 10 has a first single-stage or multiple-stage groove 212 and a first guiding groove 213 disposed on a first lateral surface thereof, and the first guiding groove 213 is adjacent to the first single-stage or multiple-stage groove 212.

The slidable cover unit 3 includes a top cover 30A and a bottom cover 30B mated together or integrated with each other to form a one-piece element, and the slidable cover unit 3 can slidably covers the wireless network receiving module 10. The slidable cover unit 3 has a first guiding pin 22 with U shape formed on the first inner surface thereof and corresponding to the first single-stage or multiple-stage groove 212 and the first guiding groove 213. One part 22A of the first guiding pin 22 is positioned on the first inner surface of the slidable cover unit 3, and the first guiding pin 22 has a first end 22B and a second end 22C extended toward the substantially same direction. The first end 22B of the first guiding pin 22 is selectively positioned in a first position (as shown in FIG. 7B) or a second position (as shown in FIG. 7C) in the first single-stage or multiple-stage groove 212 by pressing the slidable cover unit 3, thus the electrical connector C can be selectively hidden in the slidable cover unit 3 (as shown in FIG. 7B) or exposed from the slidable cover unit 3 (as shown in FIG. 7C) according to the position of the first end 22B of the first guiding pin 22 positioned in the first position or the second position of the first single-stage or multiple-stage groove 212. In addition, the second end 22C of the first guiding pin 22 can be also selectively positioned in a first position (as shown in FIG. 7B) or a second position (as shown in FIG. 7C) in the first guiding groove 213 by pressing the slidable cover unit 3. Moreover, the elastic unit has at least one elastic element 23 positioned between the wireless network receiving module 10 and the slidable cover unit 3.

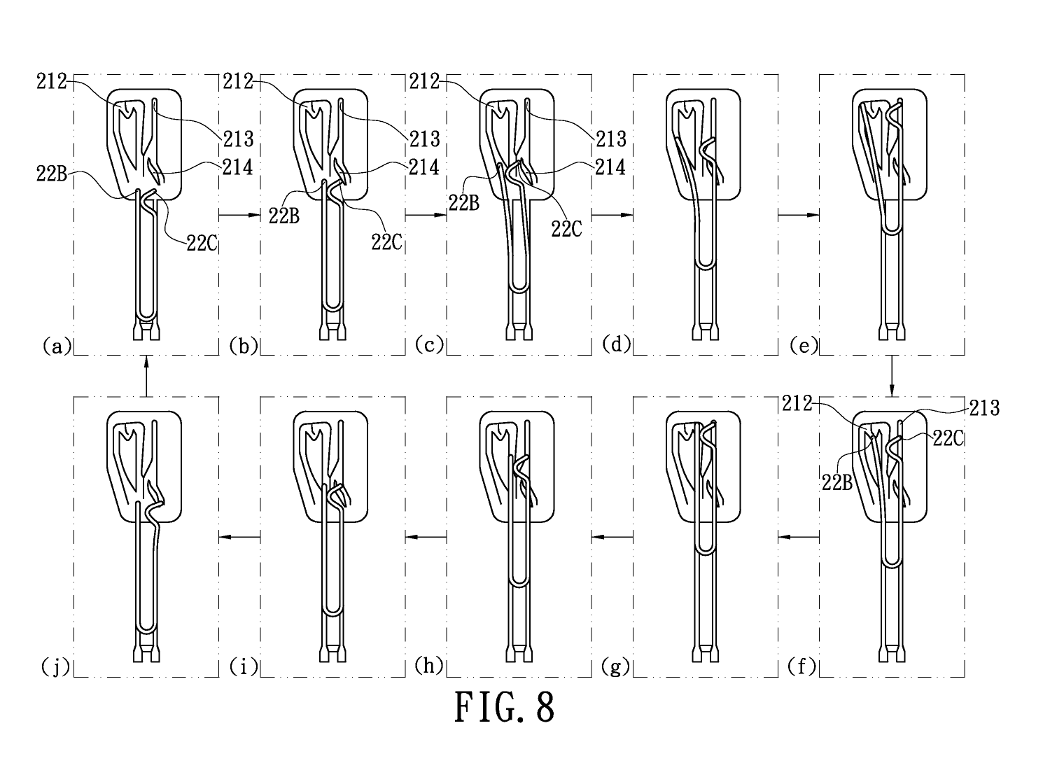

Referring to FIG. 8, the two ends (22B, 22C) of the guiding pin 22 are respectively slidably disposed in the single-stage groove 212 and the guiding groove 213, and both the bottom surface of the single-stage groove 212 and the bottom surface the guiding groove 213 are planes. In other words, the two ends (22B, 22C) of the guiding pin 22 can be respectively slid in the single-stage groove 212 and the guiding groove 213 (shown as the circulation from the step (a) to the step (j) in FIG. 8), and when the end 22B of the guiding pin 22 is pushed by the convex island 214 (as shown from the step (b) to the step (c) in FIG. 8), the end 22B of the guiding pin 22 can enter the single-stage groove 212 smoothly.

In addition, the step (a) means the single-stage groove 212 and the guiding groove 213 are positioned in the first position, and the step (f) means the single-stage groove 212 and the guiding groove 213 are positioned in the second position. Therefore, in the sixth and the seventh embodiments, the first end 22B of the guiding pin 22 is selectively positioned in a first position or a second position in the single-stage groove 212 and the second end 22C of the guiding pin 22 is selectively positioned in a first position or a second position in the guiding groove 213 by pressing the slidable cover unit 3 at the same time, thus the electrical connector C can be selectively hidden in the slidable cover unit 3 or exposed from the slidable cover unit 3 according to the position of the first end 22B positioned in the first position or the second position of the single-stage groove 212 and according to the position of the second end 22C positioned in a first position or a second position of the guiding groove 213.

In conclusion, the electrical connector can be selectively hidden in the slidable cover unit or exposed from the slidable cover unit by repeatedly pressing the end of the wireless network receiving unit.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A wireless network receiver for selectively receiving or exposing an electrical connector, comprising:
a wireless network receiving unit including a wireless network receiving module, wherein the electrical connector is electrically connected to and disposed on one end of the wireless network receiving module;
a two-stage switch unit including a movable module disposed in the wireless network receiving module, wherein the movable module is selectively positioned in a first position or a second position; and
a slidable cover unit covering slidably one part of the wireless network receiving module and connecting the two-stage switch unit, wherein the electrical connector is selectively received by or exposed from the slidable cover unit according to the position of the movable module in the first position or the second position.

2. The wireless network receiver as claimed in claim 1, wherein the electrical connector is a USB connector.

3. The wireless network receiver as claimed in claim 1, wherein the two-stage switch unit includes a hollow casing positioned in the wireless network receiving module, the first position and the second position are formed in the hollow casing, and the movable module is slidably disposed in the hollow casing and selectively positioned in the first position or the second position of the hollow casing.

4. The wireless network receiver as claimed in claim 3, wherein the two-stage switch unit includes a guiding pin disposed in the hollow casing and an elastic element disposed between the inner surface of the hollow casing and the movable module, the movable module includes a movable body, at least one protruding movable block disposed on the movable body and exposed from the hollow casing and a multiple-stage groove formed on the movable body, one end of the guiding pin is positioned in the hollow casing, and the other end of the guiding pin is slidably disposed in the multiple-stage groove and selectively positioned in a first position or a second position in the multiple-stage groove.

5. The wireless network receiver as claimed in claim 4, wherein the slidable cover unit has a top cover and a bottom cover mated together, the slidable cover unit has at least one fixing groove formed on the inner surface thereof to receive and fix the at least one protruding movable block.

6. The wireless network receiver as claimed in claim 3, wherein the two-stage switch unit includes a guiding pin disposed in the hollow casing and an elastic element disposed between the inner surface of the hollow casing and the movable module, the movable module includes a movable body, at least one movable groove disposed on the movable body and a multiple-stage groove formed on the movable body, one end of the guiding pin is positioned in the hollow casing, and the other end of the guiding pin is slidably disposed in the multiple-stage groove and selectively positioned in a first position or a second position in the multiple-stage groove.

7. The wireless network receiver as claimed in claim 6, wherein the slidable cover unit has a top cover and a bottom cover mated together, the slidable cover unit has at least one fixing block formed on the inner surface thereof and fixedly received in the at least one movable groove.

8. A wireless network receiver for selectively receiving or exposing an electrical connector, comprising:
a slidable cover unit;
a two-stage switch unit including a movable module disposed in the slidable cover unit, wherein the movable module is selectively positioned in a first position or a second position in the slidable cover unit;
a wireless network receiving unit including a wireless network receiving module, wherein the electrical connector is electrically connected to and disposed on one end of the wireless network receiving module, the wireless network receiving module is coupled to the two-stage switch unit, and the electrical connector is selectively received by or exposed from the slidable cover unit according to the position of the movable module in the first position or the second position.

9. The wireless network receiver as claimed in claim 8, wherein the electrical connector is a USB connector, and the slidable cover unit has a top cover and a bottom cover mated together.

10. The wireless network receiver as claimed in claim 8, wherein the two-stage switch unit includes a hollow casing positioned in the slidable cover unit, the first position and the second position are formed in the hollow casing, and the movable module is slidably disposed in the hollow casing and selectively positioned in the first position or the second position of the hollow casing.

11. The wireless network receiver as claimed in claim 10, wherein the two-stage switch unit includes a guiding pin disposed in the hollow casing and an elastic element disposed between the inner surface of the hollow casing and the movable module, the movable module includes a movable body, at least one protruding movable block disposed on the movable body and exposed from the hollow casing and a multiple-stage groove formed on the movable body, one end of the guiding pin is positioned in the hollow casing, and the other end of the guiding pin is slidably disposed in the multiple-stage groove and selectively positioned in a first position or a second position in the multiple-stage groove.

12. The wireless network receiver as claimed in claim 11, wherein the wireless network receiving module has at least one fixing groove formed on the outer surface thereof to receive and fix the at least one protruding movable block.

13. The wireless network receiver as claimed in claim 10, wherein the two-stage switch unit includes a guiding pin disposed in the hollow casing and an elastic element disposed between the inner surface of the hollow casing and the movable module, the movable module includes a movable body, at least one movable groove disposed on the movable body and a multiple-stage groove formed on the movable body, one end of the guiding pin is positioned in the hollow casing, and the other end of the guiding pin is slidably disposed in the multiple-stage groove and selectively positioned in a first position or a second position in the multiple-stage groove.

14. The wireless network receiver as claimed in claim 13, wherein the wireless network receiving module has at least one fixing block formed on the outer surface thereof and fixedly received in the at least one movable groove.

15. A wireless network receiver for selectively receiving or exposing an electrical connector, comprising:
a wireless network receiving unit including a wireless network receiving module, wherein the electrical connector is electrically connected to and disposed on one end of the wireless network receiving module, the wireless network receiving module has a first guiding pin disposed on a first lateral surface thereof, and one part of the first guiding pin is positioned on the first lateral surface of the wireless network receiving module;
a slidable cover unit slidably covering the wireless network receiving module, wherein the slidable cover unit has a first single-stage or multiple-stage groove formed on a first inner surface thereof and corresponding to the first guiding pin, a first end of the first guiding pin is selectively positioned in a first position or a second position in the first single-stage or multiple-stage groove by pressing the slidable cover unit, and the electrical connector is selectively received by or exposed from the slidable cover unit according to the position of the first end of the first guiding pin in the first position or the second position in the first single-stage or multiple-stage groove; and
an elastic unit having at least one elastic element positioned between the wireless network receiving module and the slidable cover unit.

16. The wireless network receiver as claimed in claim 15, wherein the electrical connector is a USB connector, the at least one elastic element is a compression spring, the slidable cover unit has a first guiding groove formed on the first inner surface thereof and adjacent to the first single-stage or multiple-stage groove, and a second end of the first guiding pin is selectively positioned in a first position or a second position in the first guiding groove by pressing the slidable cover unit.

17. The wireless network receiver as claimed in claim 15, wherein the wireless network receiving module has a second guiding pin disposed on a second lateral surface thereof, one part of the second guiding pin is positioned on the second lateral surface of the wireless network receiving module, the slidable cover unit has a second single-stage or multiple-stage groove formed on a second inner surface thereof and corresponding to the second guiding pin, a first end of the second guiding pin is selectively positioned in a first position or a second position in the second single-stage or multiple-stage groove by pressing the slidable cover unit, the electrical connector is selectively received by or exposed from the slidable cover unit according to the position of the first end of the second guiding pin in the first position or the second position in the second single-stage or multiple-stage groove, the slidable cover unit has a second guiding groove formed on the second inner surface thereof and adjacent to the second single-stage or multiple-stage groove, and a second end of the second guiding pin is selectively positioned in a first position or a second position in the second guiding groove by pressing the slidable cover unit.

18. A wireless network receiver for selectively receiving or exposing an electrical connector, comprising:
a wireless network receiving unit including a wireless network receiving module, wherein the electrical connector is electrically connected to and disposed on one end of the wireless network receiving module, and the wireless network receiving module has a first single-stage or multiple-stage groove disposed on a first lateral surface thereof;
a slidable cover unit slidably covering the wireless network receiving module, wherein the slidable cover unit has a first guiding pin formed on a first inner surface thereof and corresponding to the first single-stage or multiple-stage groove, one part of the first guiding pin is positioned on the first inner surface of the slidable cover unit, a first end of the first guiding pin is selectively positioned in a first position or a second position in the first single-stage or multiple-stage groove by pressing the slidable cover unit, and the electrical connector is selectively received by or exposed from the slidable cover unit according to the position of the first end of the first guiding pin in the first position or the second position in the first single-stage or multiple-stage groove; and
an elastic unit having at least one elastic element positioned between the wireless network receiving module and the slidable cover unit.

19. The wireless network receiver as claimed in claim 18, wherein the electrical connector is a USB connector, the at least one elastic element is a compression spring, the wireless network receiving module has a first guiding groove formed on the first lateral surface thereof and adjacent to the first single-stage or multiple-stage groove, and a second end of the first guiding pin is selectively positioned in a first position or a second position in the first guiding groove by pressing the slidable cover unit.

20. The wireless network receiver as claimed in claim 18, wherein the wireless network receiving module has a second single-stage or multiple-stage groove disposed on a second lateral surface thereof, the slidable cover unit has a second guiding pin formed on a second inner surface thereof and corresponding to the second single-stage or multiple-stage groove, one part of the second guiding pin is positioned on the second inner surface of the slidable cover unit, a first end of the second guiding pin is selectively positioned in a first position or a second position in the second single-stage or multiple-stage groove by pressing the slidable cover unit, the electrical connector is selectively received by or exposed from the slidable cover unit according to the position of the first end of the second guiding pin in the first position or the second position in the second single-stage or multiple-stage groove, the wireless network receiving module has a second guiding groove formed on the second lateral surface thereof and adjacent to the second single-stage or multiple-stage groove, and a second end of the second guiding pin is selectively positioned in a first position or a second position in the second guiding groove by pressing the slidable cover unit.
